(19) United States
(12) Patent Application Publication
(10) Pub. No.: US 2015/0080775 A1
(43) Pub. Date: Mar. 19, 2015

(54) LYMPHATIC SYSTEM MOVER

(71) Applicant: Konstantinos PAPADOPOULOS, Lincolnwood, IL (US)

(72) Inventor: Konstantinos PAPADOPOULOS, Lincolnwood, IL (US)

(21) Appl. No.: 14/031,094

(22) Filed: Sep. 19, 2013

(51) Int. Cl. A61H 9/00; A61H 1/00

(52) U.S. Cl. CPC A61H 9/005; A61H 1/008; A61H 2201/0103
USPC 601/151

(57) ABSTRACT

The present invention is comprised of an inflatable sleeve system that may fit around a patient's limb, core or any other portion of his or her body. The system is comprised of a sleeve and pressure intake means that supplies air pressure to the sleeve. The sleeve of the present invention comprises at least three cylindrical inflatable chambers arranged longitudinally along the axis of the sleeve.

### BACKGROUND OF THE INVENTION

The present invention relates to a therapeutic device used to promote lymphatic circulation throughout any portion of a patient or healthy person's body.

It is known that patients who are forced to be bed ridden have poor circulation in their limbs due to being confined for long periods of time to a bed. Such confinement has detrimental effects due to the lack of proper flow of the lymphatic system which can lead to edema and other illnesses. It is desirable therefore to provide a device that is both easy to place around a patient's limb and can improve circulation to such immobile patients in order to enhance the lymphatic system circulation by promoting interaction between white blood cells (WBC) and pathogens or to prevent lymph buildup.

### SUMMARY OF THE INVENTION

The present invention is comprised of an inflatable sleeve system that may fit around a patient's limb, core, or any other portion of his or her body. The system is comprised of a sleeve and pressure intake means that supplies air pressure to the sleeve. The sleeve of the present invention comprises at least three cylindrical inflatable chambers arranged longitudinally along the axis of the sleeve. Each chamber has at least one one-way valve that allows pressure to flow from one chamber to the adjoining chamber. The chamber most distal to the pressure intake means has at least one one-way valve that allows air to exit said chamber to the exterior of the device once said pressure is reached inside it. The design of the present invention allows air pressure to build within each chamber sequentially which thereby compresses the underlying patient's or body in a sequential motion. Such compression improves the lymphatic circulation of the patient by applying circumferential pressure to the body and thereby forcing the lymphatic system to flow in the vessels in the portion of the body being treated due to the lymphatic system moving via muscle contraction which this device mimics.

The benefit of the present invention is that the pressure intake means allows the chamber most proximal to the pressure intake means to be filled with air pressure and then due to the pressure build up in such chamber, air is forced through the one way valve into the adjoining chamber. Each adjoining chamber thereby fills with air until air is forced out of the exit valve in the chamber most distal to the pressure intake means. Such sequential air pressure build up along the axis of the sleeve creates ascending or descending circumferential compression along the limb of the patient thereby improving lymph flow along such section of the patient's limb which then increases lymphatic circulation throughout the body.

Another benefit of the present invention is that the sleeve is adjustable to fit any portion of the patient's body. The sleeve has a first end and a second end that fit together to permit adjustment to various lengths to fit limbs of varying sizes. Furthermore, the sleeve of the present invention may be used laid out flat on a bed to massage a person's neck, back, or other parts of the body in a sequential motion.

### DESCRIPTION OF THE DRAWINGS

FIG. 1 is a top view of the present invention wherein the two ends of the sleeve have been joined;

FIG. 2 is a front plan view of the present invention wherein the two ends of the sleeve are not joined; and

FIG. 3 is a perspective view of the sleeve of FIG. 1.

### DETAILED DESCRIPTION OF THE DRAWINGS

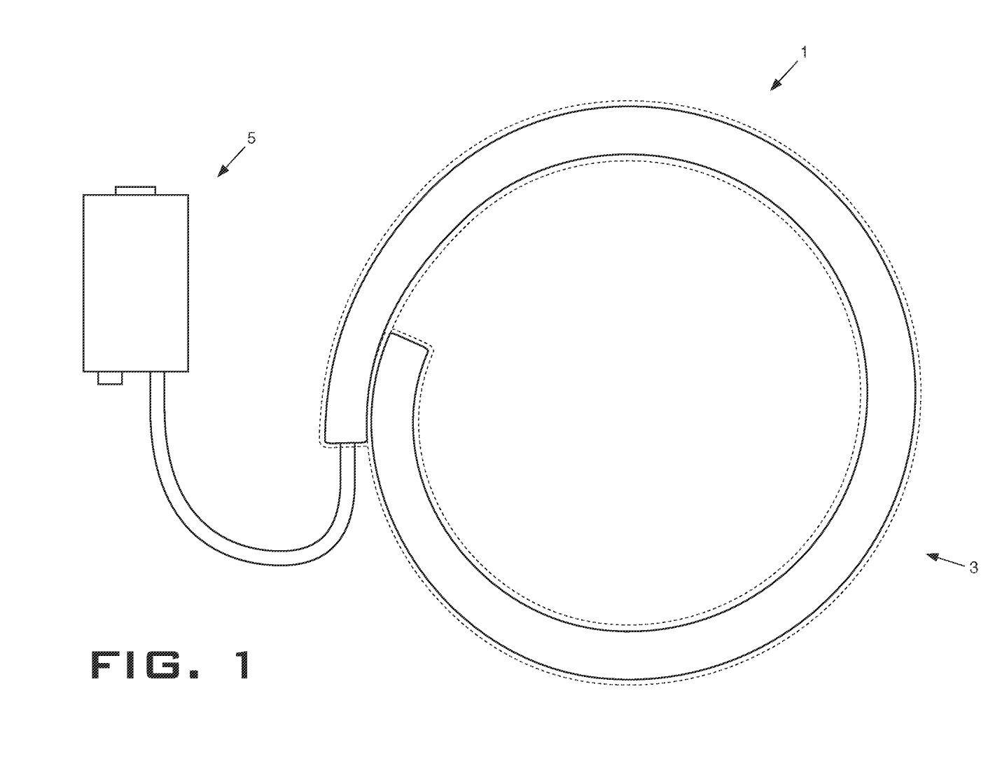

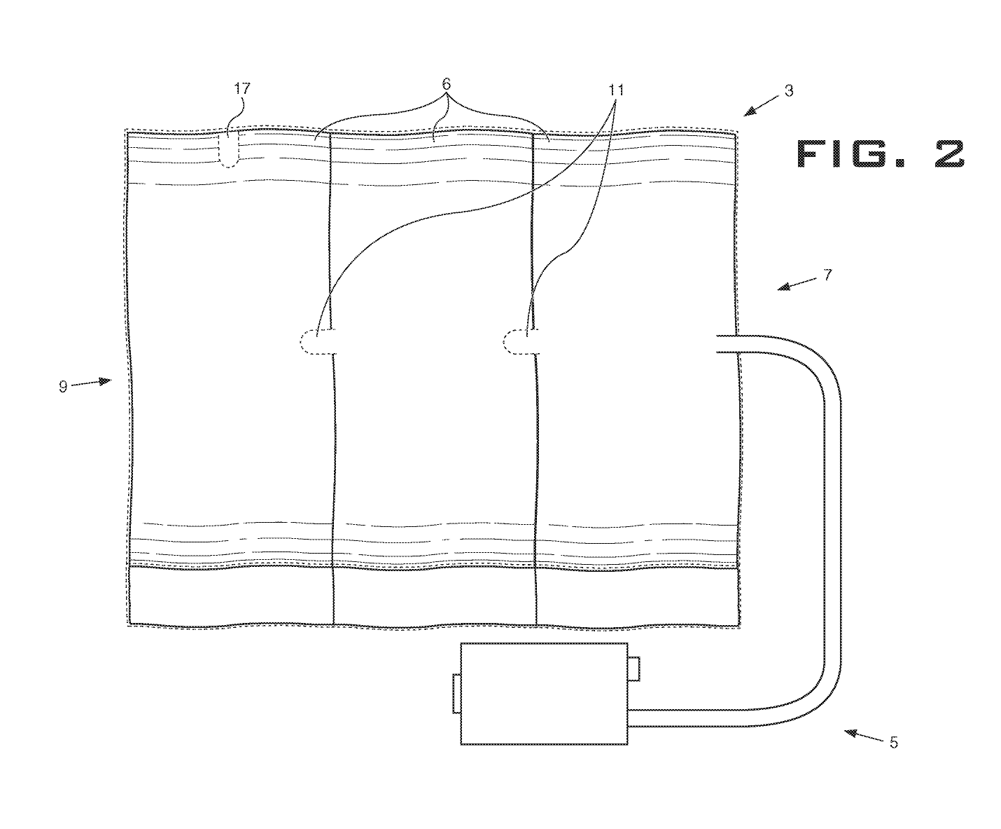

Referring now to FIG. 1, a device is shown generally at 1 that provides circumferential compressive pressures against a patient's extremities or portions of the patient's body. The device 1 is comprised of a sleeve system 3 and pressure intake means 5 that supplies air pressure to the sleeve 3. As shown in FIG. 2, the sleeve system 3 has at least three cylindrical inflatable chambers 6 arranged longitudinally along the vertical axis of the sleeve 3. Each chamber also possesses at least one one-way valve 11 connecting the adjoining chambers. Each chamber therefore has at least one one-way valve 11 that allows pressure to flow from one chamber to the adjoining chamber. The present invention is designed such that each chamber 6 sequentially fills with air and when each chamber has reached its maximum capacity, the air flows through the one way valve 11 to the adjoining chamber 6. The pressure intake means 5 provides air pressure to the chamber most proximal to the pressure intake means 5 and once air pressure in said chamber reaches the maximum capacity given the volume of the chamber, air will flow through the one way valve 11 to the adjoining chamber located more distal to the pressure intake means 5 such that air pressure will ascend or descend along the longitudinal axis of the device.

The chamber at the distal end 9 of the device to the pressure intake means 5 has at least one one-way valve 17 that allows air to exit said chamber to the exterior of the device. The design of the present invention allows air pressure to build within each chamber sequentially which thereby compresses the underlying patient's or body. Such compression improves the circulation of the patient by applying circumferential pressure to the body and thereby forcing blood to flow in the vessels in the portion of the body being treated.

The benefit of the present invention is that the pressure intake means allows the chamber at the proximal end 7 of the device relative to the pressure intake means 5 to be filled with air pressure and then due to the pressure build up in such chamber, air is forced through the one way valve 11 into the adjoining chamber. Each adjoining chamber thereby fills with air until air is forced out of the exit valve in the chamber most distal to the pressure intake means 5. Such sequential air pressure build up along the axis of the sleeve creates ascending or descending circumferential compression along the limb of the patient thereby improving flow of the lymphatic system along such section of the patient's limb and then on to the rest of the body.

The pressure intake means 5 may be comprised of any conventional means to provide air pressure including but not limited to a physically operated pump connected to an inlet tube or conduit, a computer monitored pump that monitors the amount of air sent into the sleeve 3 or any other means for providing air into the sleeve 3. In one embodiment, the pressure intake means may be programmable to allow for a predetermined amount of pressure to be present in the sleeve 3. Alternatively the pressure intake means may be programmable to allow for the sleeve 3 to be pressured intermittently by sending pulses of air to be sent into the sleeve 3.

In one embodiment, the pump 15 may have a control apparatus which may control the air pressure in the sleeve. The control apparatus may allow for both the inflation of the sleeve 3 as well as deflation through the inlet tube or conduit.

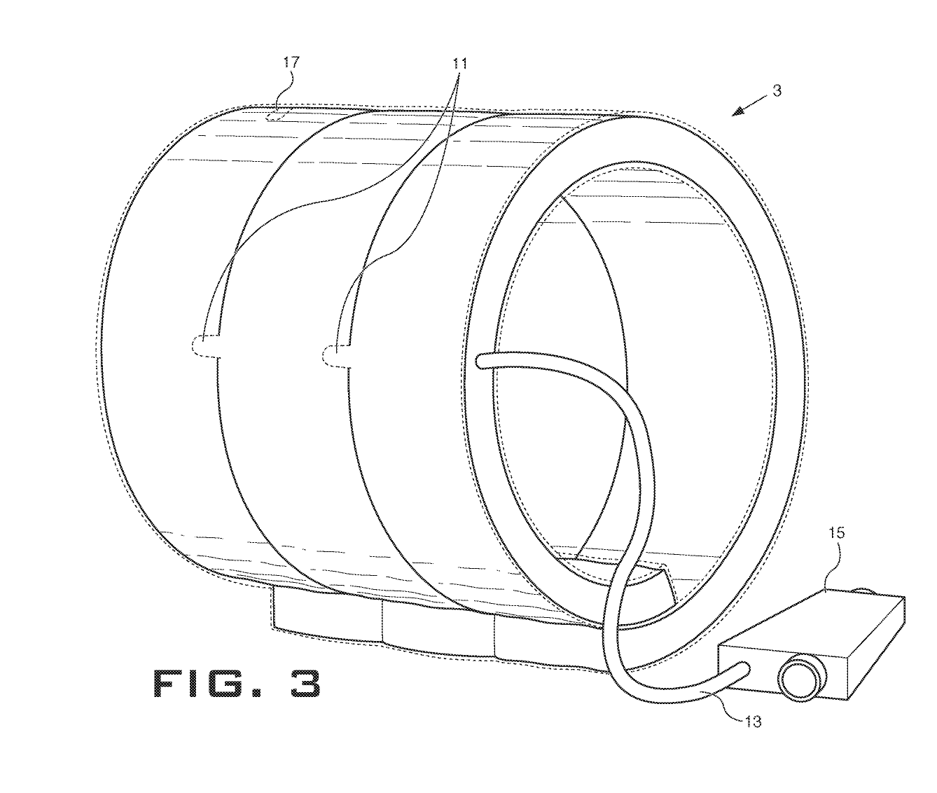

As shown in FIG. 3, the pump 15 is connected to an inlet tube or conduit 13 leading into the chamber most proximal to the pump 15.

Another benefit of the present invention is that the sleeve is adjustable to fit any portion of the patient's body. The sleeve 3 has a first end 7 and a second end 9 that fit together to permit adjustment to various lengths to fit limbs of varying sizes. The first end 7 and second end 9 may fit together using any conventional means including a hook and loop fastener such as Velcro™ or snaps or any conventional means.

The sleeve 3 may be constructed of a flexible impermeable material, such as polyvinyl chloride. The sleeve is constructed to allow the sleeve to be wrapped around a patient's limb by removably connecting the first end 7 to the second 9 of the sleeve. When the sleeve 3 inflates, the pressure within the sleeve provides compressive forces on the patient's body wrapped within.

The foregoing detailed description is given for clearness of understanding only, and no unnecessary limitations should be understood therefrom, as modifications will be obvious to those skilled in the art.

I hereby claim:

1. A therapeutic device for improving lymphatic circulation in patients, comprising:
an inflatable sleeve system having at least three inflatable chambers and an intake pressure means.
